(19) United States
(12) Patent Application Publication
(10) Pub. No.: US 2021/0340815 A1
(43) Pub. Date: Nov. 4, 2021

(54) SWING/WING GATE TURNSTILE

(71) Applicant: Gunnebo Entrance Control Ltd., Maresfield (GB)

(72) Inventor: Iain David Port, Maresfield (GB)

(21) Appl. No.: 17/283,001

(22) PCT Filed: Sep. 12, 2019
(86) PCT No.: PCT/IB2019/057682

§ 371 Date: Apr. 5, 2021

(30) Foreign Application Priority Data
Oct. 8, 2018 (IT) 102018000009238

(51) Int. Cl. E06B 11/08; E06B 11/02; E05F 15/73; A61L 2/23

(52) U.S. Cl. CPC E06B 11/085; E06B 11/02; E05F 15/73; E05Y 2900/40; E05F 2015/763; E05F 2015/765; A61L 2/23

(57) ABSTRACT

A wing/swing turnstile gate, installed at controlled entrances or exits, comprising at least: a frame; a flap; the frame comprises at least a control unit and an actuating means. The control unit is in communication with the actuating means such that the control unit is able to operate the actuating means. The flap is fixed to the actuating means of said frame such that the flap is operable, from a close position to an open position and/or vice versa when a user is present within its zone of detection, by said control unit via the actuating means. The flap is equipped with a sensing device, in communication with the control unit, apt to regulate the behavior of the flap, and/or send information of a user to the control unit to be processed.

### CROSS-REFERENCE TO RELATED APPLICATIONS

This application is the U.S. National Phase under 35 U.S.C. § 371 of International Application PCT/162019/057682, filed Jul. 31, 2019, which claims priority to IT Application No. 102018000009238, filed Oct. 8, 2018, the entire contents of each of which are incorporated by reference herein and made a part of this specification.

### BACKGROUND

### Field

The present invention, of an entrance gate, relates to a wing gate turnstile.

In particular, the present invention relates to a flap barrier of the wing gate turnstile.

### Description of the Related Art

To date, there are several smart wing gate turnstile.

In particular, wing turnstiles that are able to detect the presence of a user and operate the flap of the wing turnstile, from a close position to an open position, to allow access to a user and/or operate the flap from an open position to a close position in the absence of a user.

In particular, the sensors for the turnstile gate are arranged on the frame of the turnstile gate, preferably at the front of the frame to detect incoming user and at the end of the frame to detect outgoing user.

In particular, the sensors, for the turnstile gate, are in pairs. They have a transmitter and a receiver. Therefore, they need to be arrange in parallel facing each other, such that the signal sent from the transmitter can be assessed by the receiver. So that when the receiver, does not sense any signal, the system interprets it as an object in the space between. When the signal is regained, it is interpreted as the absence of an object or user within the space in between.

However, this form of realization presents some problems of installation, since the sensors need to be aligned perfectly in order to have a normal working of the sensors.

Moreover, this can consume time and therefore cost of installation.

In addition, since the sensors do not cover the space where the flap trajects, when an object is stationary within that region, the sensors still detects absence of an object in the passage way.

To solve this problem, more sensors are used and this also contributes to the cost.

Moreover, the sensors are fixed with respect to the frames and due to this, understanding the actual behavior of the flap during operation is difficult.

### SUMMARY

The underlying problem related to this invention is to realize a turnstile gate having a smart flap be able to analyze the actual behavior of the flap with respect to an object within its zone of action when actuated and take action that best suit the situation.

The principal purpose of the present invention is to provide a wing gate turnstile which offers a solution to the drawbacks of the wing gate turnstile described above.

Another purpose is to realize a turnstile gate provided with a smart flap that is cost effective.

A further purpose is to realize a turnstile gate with a smart flap with less installation time.

A more further purpose is to realize a turnstile gate provided with a smart flap that is hygienically safe irrelevant of the hygienic condition of the environment or users around.

Further characteristics and advantages of the present invention will be apparent from the following the detailed description of preferred but not exclusive embodiments of the wing gate turnstile according to the independent claim attached.

A wing/swing turnstile gate 100, installed at controlled entrances or exits, comprising at least:
a frame 15;
a flap 10;

said frame 15 comprises at least
a control unit 16
an actuating means 17;

said control unit 16 is in communication with said actuating means 17 such that said control unit 16 is able to operate said actuating means 17;

said flap 10 is fixed to said actuating means 17 of said frame 15 such that said flap 10 is operable, from a close position A to an open position B and/or vice versa when a user is present within its zone of detection, by said control unit 16 via said actuating means 17

characterized in that said flap 10 is equipped with a sensing device 14, in communication with said control unit 16, apt to regulate the behavior of said flap 10, and/or send information of a user to said control unit 16 to be processed.

Detailed characteristics of the according to the present invention are quoted in the corresponding dependent claims.

### BRIEF DESCRIPTION OF THE DRAWINGS

Ulterior characteristics and advantages of the present invention majorly results from the description of one form of preferred execution but not exclusive of a flap of a swing/wing gate turnstile according to the present invention, illustrated by a non-limitative example in the accompanying drawings, in which:

FIG. 1 illustrates flap of wing gate turnstile;

FIG. 2 illustrates sectional Z-Z;

FIG. 3 illustrates a side view of wing turnstile of a second form of realization;

FIG. 4 illustrates a block scheme the present invention of the operating unit of the wing turnstile and its relation with the flap in the present forms of realization;

FIG. 5 illustrate wing turnstile of the second form of realization from a front view.

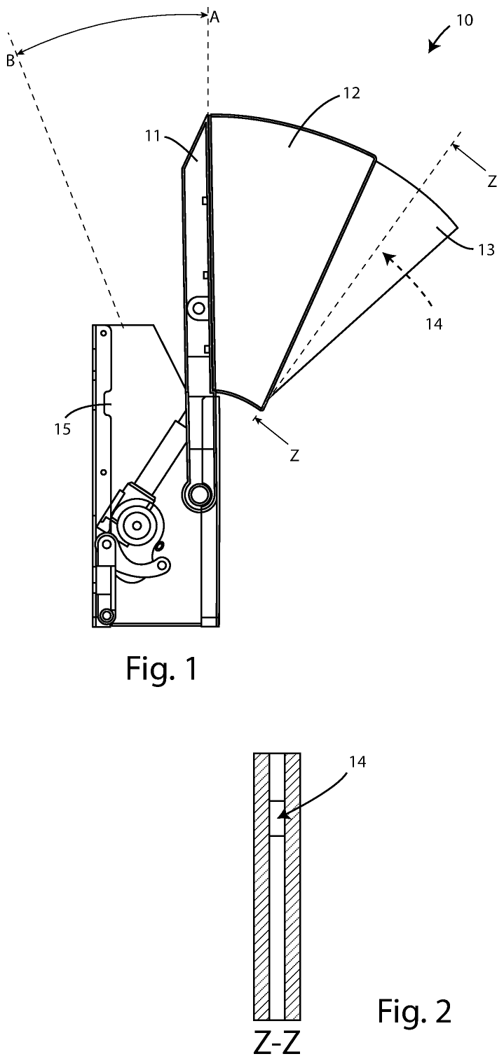

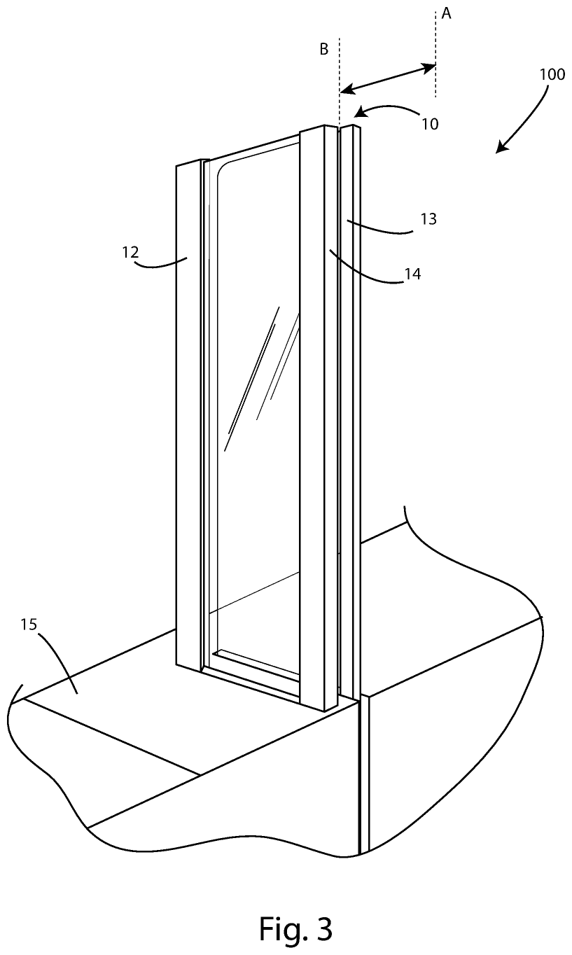

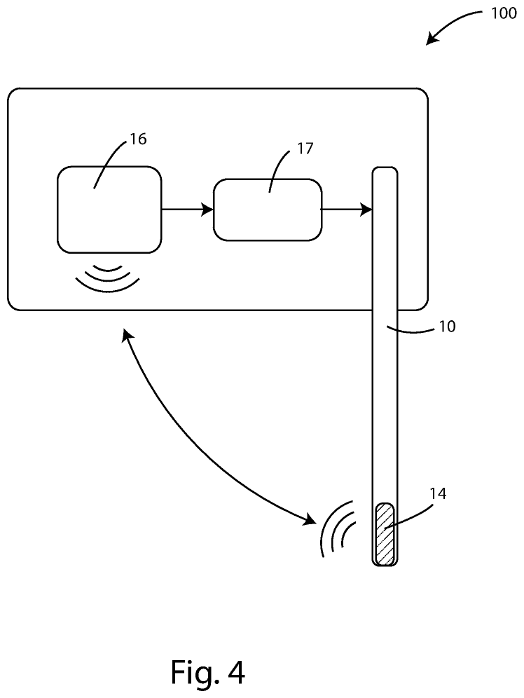

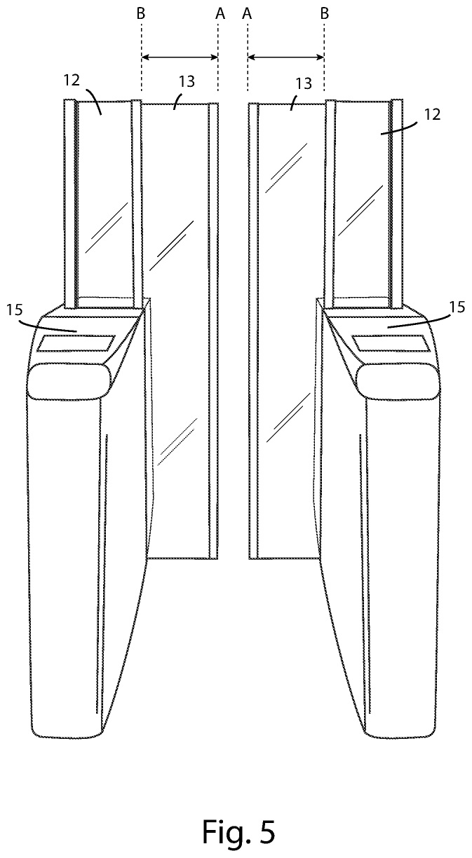

It is noted that anything found to be already known during the patenting process is understood not to be claimed and to be the subject of a disclaimer.

### DETAILED DESCRIPTION

With reference to the figures, the reference numeral 100 generally designates a wing gate turnstile installed at controlled entrances or exits comprising at least:
a frame 15;
a flap 10;

the frame 15 comprises at least
a control unit 16
an actuating means 17.

The control unit 16 is in communication with the actuating means 17 such that the control unit 16 is able to operate the actuating means 17.

The flap 10 is fixed to the actuating means 17 of said frame 15 such that the flap 10 is operable, from a close position A to an open position B and/or vice versa when a user is present within its zone of detection, by the control unit 16 via said actuating means 17.

In a first form of realization, the flap 10 comprises at least;
a stem 11;
a first plate 12.

The first plate 12 is firmly fixed to the stem 11, preferably by means of fasteners, preferably by adhesives. One end of the stem 11 is fixed to a pivot of the frame (15) of the wing turnstile such that the stem 11 is rotatable about the pivot.

The flap 10 is operable from a close position A to an open position B, and vice versa, by means of an operating unit of the wing turnstile 100. The operating unit is able to operate the flap 10 from a closed position A to an open position B, and/or vice versa.

The flap 10 is equipped with a sensing device 14. The sensing device 14 is in communication with the operating unit of the wing turnstile, constantly sending information of the behavior of the flap 10 with respect to an object, to the actuating unit.

The operating unit is preferably installed to said frame 15 or in said frame 15.

The operating unit comprises at least an actuating means 17 preferably a linear actuator, however, other forms of actuations are envisaged.

The operating unit comprises a control unit 16.

The sensing device 14 is preferably embedded within the first plate 12.

Preferably, the flap comprises a second plate 13 telescopically fixed to the first plate 12.

Preferably said plates 12, 13 have an annular sector shape.

Preferably, the second plate 13 is operable independently with respect to the first plate 12 and vice versa.

Preferably, the first and second plate 12, 13 are operable simultaneously with respect to each other.

Preferably, the first and second plate 12, 13 are operable at different adjustable speeds with respect to each other.

Preferably, the sensing device 14 is embedded within the second plate 13.

The sensing device 14 moves with the flap 10 when the flap is operated from a close position A to an open position B and/or vice versa.

Preferably the sensing device 14 comprises a transducer. Preferably the transducer is an ultrasonic transducer used for clear object detection by transmitting ultrasonic sound waves and receiving the reflected sound waves from any object in its path.

The sensing device 14, preferably, comprise a processing unit apt to analyze the signals received, deriving information of the distance or proximity of the first plate 12, when the sensing device 14 is embedded within the first plate, or the second plate 13, when the sensing device 14 is embedded within the second plate 13, from the object reflecting the signals and take necessary action by communicating said information to the operating unit to operate said flap 10.

The sensing device 14 is able to evaluate the distance of the object with respect to the flap 10 based on the total time taken from transmitting and receiving the reflected wave from the object.

When the flap 10 is actuated, the ultrasonic transducer of the sensing device 14 continuously emits ultrasonic sound waves. The flap 10 is able to continuously analyze the distance of the first plates 12 or the second plate 13 with respect to an object within the zone of operation of the flap 10. These information are constantly communicated to the operating unit, which then stops, or slows down the speed of the flap 10 depending on the information received.

Preferably, the sensing device 14 is able to evaluate the distance or proximity of the flap 10 from the object and the speed at which the flap 10 is travelling.

Moreover, it is also able to understand the displacement in time of the object as well, within the zone of operation of the flap 10.

Based on this information, it is able to calculate possible results, such as time of impact, force of impact etc. It also decides on a possible solution, such as reducing the speed at which the plates 12 and/or 13 are operated if the object is transmitting at a speed safe enough to avoid impact or stop the plates 12 or/and 13 in the case whereby impact is inevitable. The decision is sent to the operating unit, which then operates the actuating means 17 to execute the decision taken by the sensing device 14.

Preferably, the sensing device 14 only sends signal information it receives from the object to the operating unit, the control unit 16 of the operating unit takes decision, evaluating the information it receives from the sensing device 14.

Preferably, the sensing device 14 comprises an IR sensor. In this case the IR sensor is able to pick up the body temperature of a user within the zone of operation of the flap 10. With this system it is possible to determine the proximity of the flap 10 to the user. Depending on the proximity, the sensing devices 14 sends in formation to the control unit 16, in order to operate the actuating means 17, to stop or slow or reverse the direction of action of the flap 10.

Preferably, the sensing device 14 comprises a capacitive sensor, able to sense the proximity of the flap 10 to an object. Depending on the proximity, the sensing devices 14 sends in formation to the control unit 16, in order to operate the actuating means 17, to stop or slow or reverse the direction of action of the flap 10.

In a second form of realization the flap 10 comprises
a stem 11;
a first plate 12;
a second plate 13;
a sensing device 14.
the stem 11 is fixed solidly to said frame 15.

The first plate 12 is solidly fixed to said stem 11 and the second plate 13 is fixed to the frame 15 in such a way that the second plate 13 is slidable from a close position A to an open position B and/or vice versa when operated by the control unit 16 via the actuating means 17.

The sensing device 14 is fixed to the first plate 12. Preferably the sensing device 14 is fixed substantially along the total area defined by the width and height of the flap 10, in particular, the area defined, faces the entrance of the gate 100.

Preferably, the sensing device 14 is apt to measure the height of a user crossing through the turnstile gate 100.

Preferably, the plate 12, 13, in this form of realization, have a rectangular shape.

However, other geometrical shapes adaptable to the present invention as described are envisaged.

The flap can also be termed as a smart flap.

Advantageously, the flap 10 comprises antimicrobial additive apt to impede the growth of bacteria, viruses etc. Preferably the antimicrobial additive is comprised in the first and second plate 12, 13.

Preferably, the antimicrobial additive infused in the first and second plate 12, 13.

This forms of flap 10 can be used in hospitals, public washrooms etc. where high level of hygiene is needed to avoid the spread of viruses and bacteria etc.

The invention thus conceived is susceptible of numerous modifications and variations, all of which are within the scope of the appended claims; all the details may further be replaced with other technically equivalent elements.

It is to be noted that this invention can applicable to a swing turnstile.

In practice, materials used, as well as the contingent shapes and dimensions, may be any according to the requirements and the state of art.

Where the constructional characteristics and techniques mentioned in the following claims are followed by reference signs or numbers, such signs and reference numbers have been applied with the sole purpose of increasing the intelligibility of the claims and consequently, they do not constitute in any way limiting the interpretation of each element identified, purely by way of example, by such signs and reference numbers.

1. A wing/swing turnstile gate configured to be installed at controlled entrances or exits, the wing/swing turnstile gate comprising:
a frame; and
a flap;
wherein said frame comprises:
a control unit; and
an actuating means;
wherein said control unit is in communication with said actuating means such that said control unit is able to operate said actuating means;
wherein said flap is fixed to said actuating means of said frame such that said flap is operable, from a close position to an open position and/or vise versa when a user is present within its zone of detection, by said control unit via said actuating means; and
wherein said flap is equipped with a sensing device in communication with said control unit, the sensing device configured to regulate the behavior of said flap and/or send information of a user to said control unit to be processed.

2. A wing/swing turnstile gate according to claim 1, wherein said flap comprises:
a stem;
a first plate; and
a second plate;
wherein said stem is fixed solidly to said frame; and
wherein said first plate is solidly fixed to said stem and said second plate is fixed to said frame in such a way that said second plate is slidable from said close position to said open position and vice versa when operated by said control unit via said actuating means, wherein the sensing device is fixed to said first plate.

3. A wing/swing turnstile gate according to claim 1, wherein said flap comprises:
a stem configured to rotate about a pivot, of said frame, from said close position to an open position and/or vice versa;
a first plate; and
wherein said stem is firmly fixed to said first plate and said sensing device is embedded within said first plate.

4. A wing/swing turnstile gate according to claim 3, wherein said flap comprises a second plate telescopically fixed to said first plate and said sensing device is embedded within said second plate.

5. A wing/swing turnstile gate according to claim 1, wherein said sensing device comprises a transducer configured to transmit and receive signals from an object within a zone of operation of the flap.

6. A wing/swing turnstile gate according to claim 2, wherein said sensing device comprises a processing unit configured to analyze the signals received, derive information of the distance of said first plate or said second plate from the object reflecting the signals, and communicate said information to the actuating means in order to operate said flap.

7. A wing/swing turnstile gate according to claim 2, wherein said first plate and said second plate are independently or simultaneously operable with respect to each other by said sensing device.

8. A wing/swing turnstile gate according to claim 1, wherein said sensing device is configured to make use of an IR, ultrasonic, or capacitive sensor.

9. A wing/swing turnstile gate according to claim 2, wherein at least one of said first plate or said second plate is infused with an antimicrobial additive.

10. A wing/swing turnstile gate according to claim 2, wherein said first plate and said second plate have an annular sector shape.
